(19) United States
(12) Patent Application Publication
(10) Pub. No.: US 2008/0041952 A1
(43) Pub. Date: Feb. 21, 2008

(54) Subscriber identity module card and method of recognizing the same

(75) Inventor: Byung-Han Kang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/732,364

(22) Filed: Apr. 3, 2007

(30) Foreign Application Priority Data
Jun. 29, 2006 (KR) 2006-0059674

(51) Int. Cl. G06K 7/06; G06K 13/00; H01R 24/00

(52) U.S. Cl. 235/441; 235/475; 439/630

(57) ABSTRACT

Provided are a Subscriber Identity Module (SIM) card and a method of recognizing the SIM card. A mobile communication terminal to which the SIM card applies has a card installation slot with predetermined connectors. A SIM card is detachably installed in the card installation slot, and includes a first contact pad cluster that has a plurality of contact pads to electrically contact the connectors when the SIM card is installed in a correct direction, and a second contact pad cluster on a same side of the SIM card as the first contact pad cluster, that has a plurality of contact pads to electrically contact the connectors when the SIM card is installed in a direction opposite to the correct direction. The first and the second contact pad Clusters have at least two shared contact pads. The mobile communication terminal has a switching device to switch the at least two shared contact pads, and a controller to read the SIM card connected to the connectors and to simultaneously control the switching device.

### PRIORITY

This application claims priority under 35 U.S.C. §119 to an application filed in the Korean Intellectual Property Office on Jun. 29, 2006 and assigned Ser. No. 2006-59674, the contents of which are incorporated herein by reference.

### BACKGROUND OF THE INVENTION

1. Field of the Invention

The present invention relates generally to a Subscriber Identity Module (SIM) card applicable to a mobile communication terminal, and in particular, to a SIM card configured so that subscriber data therein is recognizable by a mobile communication terminal regardless of the inserted direction of the card, and to a method of recognizing the card.

2. Description of the Related Art

In general, a wireless mobile communication terminal of the Global System for Mobile communications (GSM) standard employs a detachable SIM card. A SIM card stores data on the subscriber of the terminal and data related to the system of the terminal. Thus, with data stored in such a SIM card, a user can use any mobile communication terminal to which the SIM card can be applied. That is, a SIM card stores a user's call history, the user's settings for a terminal, system data, etc., so that when the SIM card is inserted and used in another compatible terminal, the data and settings on the SIM card are applied in the new terminal as they were in the user's original terminal. Due to this convenient advantage of SIM cards, there is a recent trend of applying a similar User Identity Module (UIM) to Code Division Multiple Access (CDMA) standard mobile communication terminals.

With respect to the layout of a SIM card (which is a plastic flash memory card), the SIM card is installed in a socket or other niche in a card mount of a terminal so that the card is electrically connected to the terminal. Here, one side of the SIM card has a plurality of contact pads of predetermined size installed thereon, so that the pads physically contact corresponding connectors installed in the socket of the terminal. More specifically, the card has 6 contact pads that are SIM_GND, SIM_VDD, SIM_IO, SIM_CLK, SIM_RST, and SIM_VCC in order. Thus, there are a corresponding number of connectors installed in the socket of the terminal that connect to the pads.

The SIM cards are typically cut at a corner thereof to induce a user to insert the card properly in a terminal. Generally, because contact pads are installed on one side of a SIM card, a user is able to easily discern through visual inspection in which direction the card is to be installed, negating the probability of a SIM card being installed upside down.

However, due to some terminals having installation portions formed to accommodate SIM cards that do not have a corner cut, there are instances where SIM cards are inserted in the opposite direction in a terminal. In such cases where the SIM cards are inserted incorrectly in the opposite direction, the terminal will not work, so that the user is inconvenienced in having to check and re-insert the SIM card in the correct direction.

### SUMMARY OF THE INVENTION

An aspect of the exemplary embodiments of the present invention is to substantially solve at least the above problems and/or disadvantages and to provide at least the advantages described below. Accordingly, an aspect of the exemplary embodiments of the present invention is to provide a SIM card and a method of recognizing the SIM card, regardless of the inserted direction of the SIM card.

Another aspect of the exemplary embodiments of the present invention is to provide a SIM card and a method of recognizing the SIM card when the SIM card is inserted in a multi-card compatible SIM card connector of a terminal, regardless of the inserted direction of the SIM card.

A further aspect exemplary embodiments of the of the present invention is to provide a SIM card and a method of recognizing the SIM card that collectively operate when installed in a terminal without having to recheck the card's installation, increasing the level of user convenience of the terminal.

According to a first aspect of the exemplary embodiments of the present invention, there is provided a SIM card detachably installed in a terminal, in which the SIM card is electrically connected to connectors for the SIM card and the connectors are installed in the terminal. The SIM card includes a first contact pad cluster disposed on one side of the SIM card and including a plurality of contact pads spaced at regular intervals for contacting the connectors when the SIM card is installed in a correct direction; and a second contact pad cluster disposed on the one side of the SIM card and including a plurality of contact pads spaced at regular intervals for contacting the connectors and performing functions of the contact pads of the first contact pad cluster when the SIM card is installed in a direction opposite to the correct direction, whereby the SIM card is recognized by the terminal regardless of an installed direction of the SIM card in the terminal.

According to a second aspect of the exemplary embodiments of the present invention, there is provided a mobile communication terminal employing a SIM card. The mobile communication terminal includes a card installation slot disposed in the mobile communication terminal and including a plurality of connectors for recognizing a SIM card that is installed in the card installation slot; a SIM card detachably installed in the card installation slot, and including a first contact pad cluster having a plurality of contact pads for electrically contacting the connectors when the SIM card is installed in a correct direction, and a second contact pad cluster having a plurality of contact pads for electrically contacting the connectors when the SIM card is installed in a direction opposite to the correct direction, in which the first and second contact pad clusters are disposed on the same side of the SIM card; and a controller for reading the first contact pad cluster or the second contact pad cluster electrically connected to the connectors, regardless of whether the SIM card is installed in the correct direction or the opposite direction, and operating the mobile communication terminal.

According to a third aspect of the exemplary embodiments of the present invention, there is provided a method of recognizing a SIM card of a mobile communication terminal. The method includes determining whether the SIM card is installed in the card installation slot; determining whether the contact pads of the SIM card are each electrically connected correspondingly to the connectors; and sequentially switching the shared contact pads and attempting operation of the mobile communication terminal, when the corresponding contact pads of the SIM card do not respectively correspond completely to the connectors.

When the SIM card is installed in the card installation slot of the terminal, it may be determined whether the card is installed through detecting whether at least one contact pad is connected to a corresponding connector.

Because the shared contact pads are sequentially switched and operated, regardless of the inserted direction of the SIM card, a user is not inconvenienced by having to reinstall the card correctly.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view illustrating a mobile communication module with a SIM card applied thereto, according to the present invention;

FIG. 2 is a perspective view illustrating a SIM card showing the contact pads thereof according to the present invention;

FIGS. 3A and 3B are plan views illustrating SIM cards that perform the same function regardless of inserted direction, according to the present invention; and

FIG. 4 is a block diagram illustrating the main components of a terminal that perform a switching operation between shared contact points, regardless of the inserted direction of a card according to the present invention.

### DETAILED DESCRIPTION OF THE EXEMPLARY EMBODIMENTS

Exemplary embodiments of the present invention will be described herein below with reference to the accompanying drawings. In the following description, well-known functions or constructions are not described in detail since they would obscure the invention in unnecessary detail.

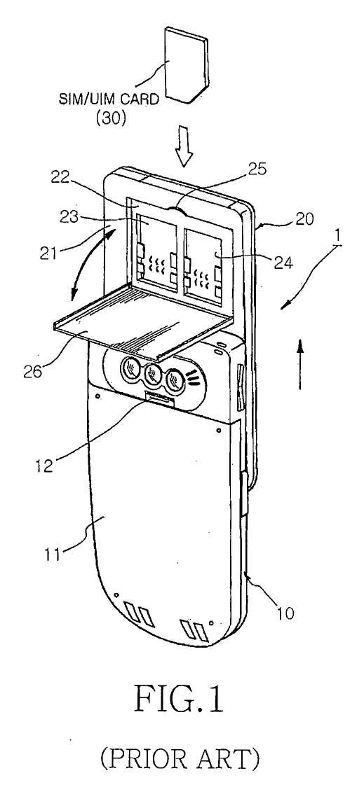

FIG. 1 shows a mobile communication terminal 1 to which a SIM card 30 is applied, where the terminal is a sliding type terminal, and two card installation slots 23 and 24 are disposed at the rear surface 21 of the sliding body 20. However, various types of terminals having multi-card SIM card connectors may be used with the SIM card 30.

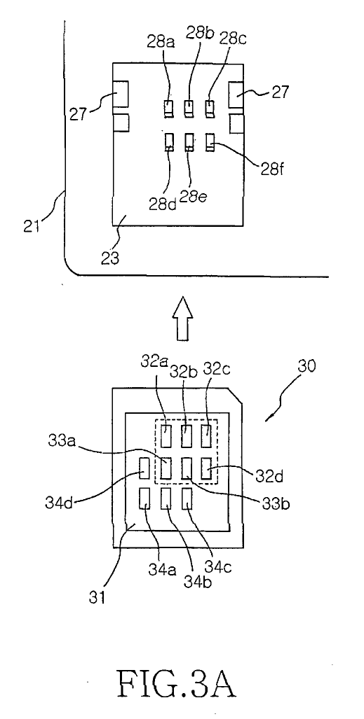

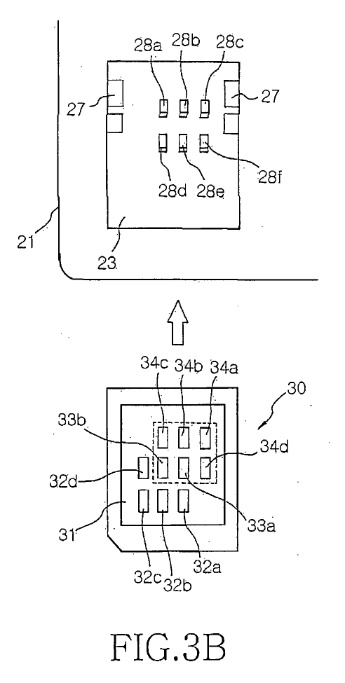

The SIM card 30 in FIG. 1 is detachably installed in the rear surface 21 of the sliding body 20. That is, with the sliding body 20 in an open state, SIM cards or UIM cards may selectively be inserted in the card installation slots 23 and 24 at the rear surface 21 of the sliding body 20. FIG. 1 shows a plurality of connectors installed directly on the card installation slots and brackets 27 (shown in FIG. 3A) extending from either side of the slots to prevent inserted SIM cards 30 from disengaging; however, the terminal may instead have a separate SIM card socket (not shown), in which the SIM card 30 may be inserted. For example, for cases where the connectors are installed directly on the card installation slots 23 and 24, or the SIM card 30 is inserted in a socket to form an electrical connection between the connectors and the SIM card 30, the connectors, which electrically connect to the contacting pads of the SIM card 30, may be formed correspondingly in the same positions with the same gaps therebetween.

In FIG. 1, a battery pack 11 for supplying power to the terminal is detachably installed to the rear surface of the main body 10 by means of a lock 12, and the card installation slots 23 and 24 are recessed within a recessed surface 22 (which is recessed within the rear surface 21 of the sliding body 20). A cover protects the card installation slots 23 and 24, and a manipulating slot 25 for easily opening and closing the cover 26 is formed on the edge of the recessed surface 22.

Although in the present invention, a SIM card and card installation slots 23 and 24 for a SIM card have been shown, a UIM card and card installation slots for UIM cards may be also applied to the exemplary embodiment of the present invention.

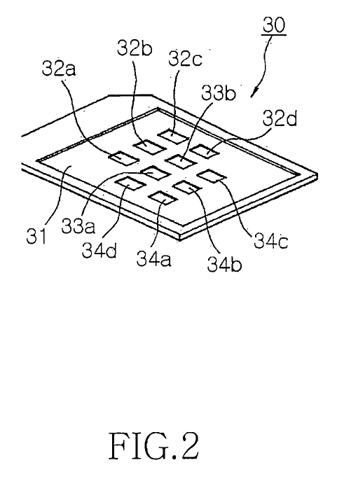

FIG. 2 is a perspective view illustrating a SIM card 30 showing the contact pads thereof according to the exemplary embodiment of the present invention, where the SIM card 30 is a plate-type plastic material with a plurality of metal contact pads that are partially exposed thereon. Thus, when the SIM card 30 is installed in a terminal 1, the connectors that are installed to protrude from the terminal are able to contact the contact pads.

Therefore, the SIM card 30, according to the exemplary embodiment of the present invention, has a plurality of contact pads formed on its surface to contact the connectors of the terminal. It is rare for users to insert the SIM card 30 so that its mounting surface 31 is upside down. This is because the metal contact pads are clearly visible, and most users will know not to mount the other side of the SIM card (with nothing but plastic) to the connectors. Therefore, the present invention relates to a rectangular SIM card capable of being properly read when it is rotated 180 degrees from its proper installing position, and to a method of recognizing the same.

Generally, a SIM card 30 has 6 pads, which may be SIM_VCC, SIM_RST, SIM_CLK, SIM_GND, SIM_IO, and SIM_VDD. Thus, there may be 6 connectors correspondingly installed on the card installation slot of a terminal. Furthermore, because a SIM card is compatible with different terminals, the positions of and gaps between the contact pads must be regular.

As shown in FIG. 2, a SIM card according to the exemplary embodiment of the present invention includes 10 SIM card contact pads 32a, 32b, 32c, 32d, 33a, 33b, 34a, 34b, 34c, and 34d. Six of these contact pads, 32a, 32b, 32c, 32d, 33a, and 33b contact the connectors of the terminal to enable operation thereof when the SIM card is inserted in a correct direction. The remaining four contact pads 34a, 34b, 34c, and 34d and the two contact pads 33a and 33b of the above-described six form six contact pads 33a, 33b, 34a, 34b, 34c, and 34d that contact the connectors of the terminal to enable operation thereof when the SIM card is inserted in the opposite direction (rotated 180 degrees from the correct direction). For convenience, the former (i.e., the contact pads in the case of correct insertion of the SIM card) will be referred to as the first contact pad cluster, and the latter (i.e., the contact pads in the case of insertion of the SIM card in the opposite direction) will be referred to as the second contact pad cluster. In other words, the first contact pad cluster operates when the SIM card is inserted in the correct direction, and the second contact pad cluster operates when the SIM card is inserted in the opposite direction.

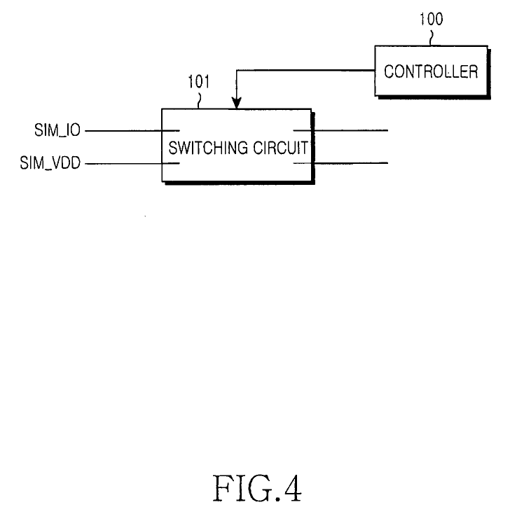

Accordingly, the contact pads, with the exception of the pads 33a and 33b shared by the first and second contact pad clusters, are installed to perform correlated functions, and these contact pads that correlate within the SIM card may be electrically connected. For example, pads 32a, 32b, 32c and 32d, respectively perform the same functions as pads 34c, 34b, 34a, and 34d of the second contact pad cluster. However, because the functions of the mutually shared pads 33a and 33b are switched in the event that the SIM card is inserted in the direction opposite to the correct direction, a switching circuit 101 (FIG. 4) that is controlled by a control unit 100 (FIG. 4) of a terminal to which a card is applied, that selectively switches the mutually shared pads 33a and 33b, is included in the terminal.

FIGS. 3A and 3B are plan views illustrating SIM cards that perform the same function regardless of inserted direction, according to the exemplary embodiment of the present invention, where FIG. 3A is a case where the SIM card is inserted in the correct direction, and FIG. 3B is a case where the SIM card is inserted in the opposite direction. Here, the contact pads of the SIM card enclosed by the dotted line in FIG. 3A is the first contact pad cluster, and the contact pads of the SIM card enclosed by the dotted line in FIG. 3B is the second contact pad cluster.

For convenience, the contact pads on the lower side of the SIM card that correspondingly contact the connectors on the rear surface of the sliding body are shown in a transparent manner from above the SIM card.

Referring to FIG. 3A, the plurality of connectors installed on the card installation slot in the rear surface of the sliding body respectively contact the contact pads of the first contact pad cluster when the SIM card is installed correctly. That is, connectors 28a, 28b, 28c, 28d, 28e, and 28f may respectively contact and concurrently perform the functions with contact pads 32a, 32b, 32c, 33a, 33b, and 32d of the first contact pad cluster.

Referring to FIG. 3B, when the SIM card is inserted in the opposite direction, connectors 28a, 28b, 28c, 28d, 28e, and 28f correspond to and contact the pads 34c, 34b, 34a, 33b, 33a, and 33d, respectively. Here, as described above, the contact pads 32a, 32b, 32c, and 32d perform the functions of contact pads 34c, 34b, 34a, and 34d, respectively. Regardless of whether the SIM card is inserted correctly or in the opposite direction, a switching circuit is used to switch the functions of the mutually shared pads 33a and 33b when the inserted direction of the card changes. The mutually shared contact pads according to the exemplary embodiment of the present invention are SIM_IO and SIM_VDD; however, these may be replaced by the remaining contact pads, and may be more than two in number.

In addition, although not shown, the first and second contact pad clusters may not have any shared contact pads. Here, the number of contact pads of the SIM card may be 12, in which case there is no need for a switching circuit.

FIG. 4 is a block diagram illustrating the main components of a terminal that perform a switching operation between shared contact points, regardless of the inserted direction of a card according to the present invention.

The controller of the terminal controls the switching circuit according to an inserted direction of the SIM card, to enable proper recognition of the SIM card and operation of the terminal. Therefore, the terminal follows the SIM card recognition process as described below.

First, the controller searches for whether the SIM card is installed in the card installation slot of the terminal. That is, if the SIM card is installed in the card installation slot, the controller searches for whether at least one contact pad is correspondingly connected to at least one of the connectors to determine whether the card is installed. Next, it is determined whether all of the contact pads of the SIM card are electrically connected to the corresponding connectors. Here, it is determined whether the contacting pads corresponding to all 6 of the connectors are electrically connected thereto. If the connection is complete, the card is read and the terminal may be operated. However, if there is an incomplete connection between the contact pads of the SIM card and the corresponding connectors, the mutually shared pads SIM_VDD and SIM_IO are switched and the SIM card is read and operated. That is, because the contact pads other than the mutually shared pads respectively perform the same functions, when only the mutually shared contact pads are switched, the card can be recognized properly to operate the terminal, regardless of the inserted direction of the SIM card.

When a SIM card according to the exemplary embodiment of the present invention is installed in a terminal, it can be recognized, regardless of its installed direction, thereby obviating the occurrence of operating errors caused by improper installation of the SIM card and having to perform the cumbersome process of re-installing the SIM card properly, thereby increasing user convenience.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A Subscriber Identity Module (SIM ) card detachably installed in a terminal, in which the SIM card is electrically connected to connectors for the SIM card and the connectors are installed in the terminal, the SIM card comprising:
a first contact pad cluster disposed on one side of the SIM card and including a plurality of contact pads spaced at regular intervals for contacting the connectors when the SIM card is installed in a correct direction; and
a second contact pad cluster disposed on the one side of the SIM card and including a plurality of contact pads spaced at regular intervals for contacting the connectors and performing functions of the contact pads of the first contact pad cluster when the SIM card is installed in a direction opposite to the correct direction,
whereby the SIM card is recognized by the terminal regardless of an installed direction of the SIM card in the terminal.

2. The SIM card of claim 1, wherein the first contact pad cluster and the second contact pad cluster are separately installed.

3. The SIM card of claim 1, wherein at least two shared contact pads from the first contact pad cluster and the second contact pad cluster perform switching contacting with the connectors, according to the installed direction of the SIM card.

4. The SIM card of claim 3, wherein the first contact pad cluster and the second contact pad cluster respectively include six contact pads, SIM_VCC, SIM_RST, SIM_CLK, SIM_GND, SIM_IO, and SIM_VDD, respectively connected electrically to the connectors, and SIM_IO and SIM_VDD perform switching contacting with the connectors, according to the installed direction of the SIM card.

5. A mobile communication terminal employing a SIM card, the mobile communication terminal comprising:
a card installation slot disposed in the mobile communication terminal and including a plurality of connectors for recognizing a SIM card that is installed in the card installation slot;
a SIM card detachably installed in the card installation slot, and including a first contact pad cluster having a plurality of contact pads for electrically contacting the connectors when the SIM card is installed in a correct direction, and a second contact pad cluster having a plurality of contact pads for electrically contacting the connectors when the SIM card is installed in a direction opposite to the correct direction, in which the first and second contact pad clusters are disposed on the same side of the SIM card; and
a controller for reading one of the first contact pad cluster and the second contact pad cluster electrically connected to the connectors, regardless of whether the SIM card is installed in the correct direction or the opposite direction, and operating the mobile communication terminal.

6. The mobile communication terminal of claim 5, wherein the first contact pad cluster and the second contact pad cluster are separately installed.

7. The mobile communication terminal of claim 5, wherein at least two shared contact pads from the first contact pad cluster and the second contact pad cluster perform switching contacting with the connectors, according to an installed direction of the SIM card.

8. The mobile communication terminal of claim 7, further comprising a switching device for receiving a control signal from the controller according to the installed direction of the SIM card, and switching the at least two shared contact pads from the first contact pad cluster and the second contact pad cluster to perform switching contacting.

9. The mobile communication terminal of claim 8, wherein the first contact pad cluster and the second contact pad cluster respectively include six contact pads, SIM_VCC, SIM_RST, SIM_CLK, SIM_GND, SIM_IO, and SIM_VDD, respectively connected electrically to the connectors, and SIM_IO and SIM_VDD perform switching contacting with the connectors, according to the installed direction of the SIM card.

10. A method of recognizing a SIM card of a mobile communication terminal, comprising the steps of:
determining whether the SIM card is installed in a card installation slot;
determining whether contact pads of the SIM card are each electrically connected correspondingly to connectors; and
sequentially switching shared contact pads and attempting operation of the mobile communication terminal, when the contact pads of the SIM card do not completely correspond to the connectors.

11. The method of claim 10, wherein a controller determines whether the SIM card is installed by checking whether at least one of the contact pads is connected to a corresponding connector, when the SIM card is installed.

12. The method of claim 11, wherein a first contact pad cluster and a second contact pad cluster respectively include six contact pads, SIM_VCC, SIM_RST, SIM_CLK, SIM_GND, SIM_IO, and SIM_VDD, respectively connected electrically to the connectors, and SIM_IO and SIM_VDD perform switching contacting with the connectors, according to an installed direction of the SIM card.
